(19) United States
(12) Patent Application Publication
(10) Pub. No.: US 2011/0168667 A1
(43) Pub. Date: Jul. 14, 2011

(54) Anti-Reflective Surfaces And Methods For Making The Same

(75) Inventor: Derrick T. Carpenter, Superior, CO (US)

(73) Assignee: Analogic Corporation, Peabody, MA (US)

(21) Appl. No.: 13/059,189

(22) PCT Filed: Aug. 17, 2009
(86) PCT No.: PCT/US09/54025

§ 371 Date: Feb. 15, 2011

Related U.S. Application Data
(60) Provisional application No. 61/089,111, filed on Aug. 15, 2008.

(51) Int. Cl. C23F 1/00; B29D 11/00; C03C 15/00

(52) U.S. Cl. 216/24

(57) ABSTRACT

In an embodiment, a method of forming an anti-reflective surface includes providing conditions for a plasma, and exposing a surface of an organic-inorganic optical material to the plasma. A treated optical material formed thereby exhibits lower reflectivity relative to the material prior to the step of exposing, forming the anti-reflective surface. In an embodiment, a method of forming an anti-reflective surface includes depositing an etch mask on a surface of an optical material, providing plasma conditions for a plasma such that the plasma etches the optical material preferentially over the etch mask, and exposing the etch mask to the plasma using the plasma conditions to form a treated optical material having a plasma-affected zone. The optical material exhibits lower reflectivity relative to said optical material prior to the step of exposing, and forms the anti-reflective surface.

### CROSS-REFERENCE TO RELATED APPLICATIONS

This application claims priority to U.S. Provisional Patent Application Ser. No. 61/089,111, filed 15 Aug. 2008, which is incorporated herein by reference in its entirety.

### BACKGROUND

Reducing reflection-induced losses from the surfaces of optical elements is often desirable in producing optical systems having highly efficient transmission of electromagnetic energy.

### SUMMARY OF THE INVENTION

In an embodiment, a method of forming an anti-reflective surface includes providing conditions for a plasma, and exposing a surface of an organic-inorganic optical material to the plasma using the conditions. A treated optical material formed thereby exhibits lower reflectivity relative to the optical material prior to the step of exposing, to form the anti-reflective surface.

In an embodiment, a method of forming an anti-reflective surface includes depositing an etch mask on a surface of an optical material, providing plasma conditions for a plasma such that the plasma etches the optical material preferentially over the etch mask, and exposing the etch mask to the plasma using the plasma conditions to form a treated optical material having a plasma-affected zone. The optical material exhibits lower reflectivity relative to said optical material prior to the step of exposing, thereby forming the anti-reflective surface.

### BRIEF DESCRIPTION OF DRAWINGS

FIG. 1 is a flow diagram illustrating one method for producing an anti-reflective optical material, in accordance with an embodiment.

FIGS. 2A and 2B show plots of reflectance and transmission versus plasma exposure time for a polymer treated with an oxygen plasma, in accordance with an embodiment.

FIG. 3 is an illustration of one system useful for plasma treatment of optical materials, in accordance with an embodiment.

FIG. 4 is an illustration of one embodiment of an optical element utilizing a deposited anti-reflective layer.

FIGS. 5A-5C are illustrations of several embodiments of anti-reflective layers and structures.

FIG. 6 is an illustration of an imaging system utilizing an anti-reflective optical material, in accord with an embodiment.

### DETAILED DESCRIPTION OF DRAWINGS

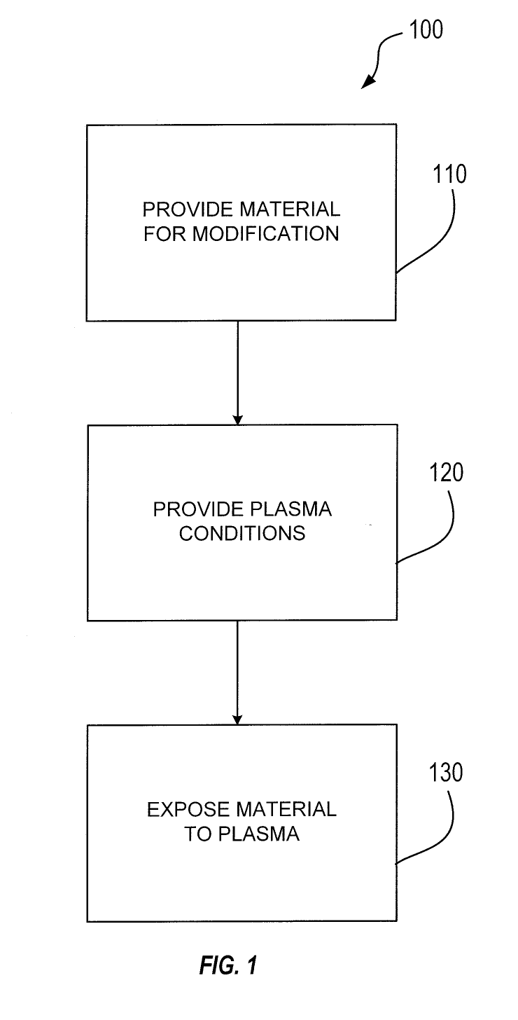

FIG. 1 illustrates a process 100 of treating an optical material to reduce reflection-related transmission loss from a surface of the optical material. In step 110, an optical material is selected for plasma treatment. In step 120, plasma conditions are selected based on the optical material selected in step 110. In step 130, the optical material is exposed to the plasma selected in step 120. Optionally, steps 120 and 130 may be repeated using the same or different plasma and/or plasma conditions. Plasma treatment of an optical material may occur before, during, or after its formation into an optical element. Thus, reference is made to treatment of “optical elements” and “optical materials” herein.

In one embodiment, an optical element is exposed to a plasma, resulting in a treated optical element that exhibits lower reflectivity than the untreated optical element. Within the context of the present disclosure, an optical element is understood to be a single element that affects the electromagnetic energy transmitted therethrough or reflected therefrom in some way. For example, an optical element may be a diffractive element, a refractive element, a reflective element or a holographic element. Optical elements are formed from any material or mixture of materials capable of transmitting, reflecting, dispersing, polarizing, diffracting or absorbing electromagnetic energy. Such materials are referred to herein as “optical materials”. Examples of optical materials include, but are not limited to, glasses, crystals, semiconductors, metals, plastics, polymers, and mixtures or hybrids thereof. Polymer optical materials may be organic, inorganic, or have both organic and inorganic components such as in inorganic-organic hybrid materials. Within the context of this disclosure, any optical material that interacts with a plasma to produce a treated optical material having a reduced surface reflection relative to the untreated optical material may be utilized. One example of such an organic-inorganic hybrid polymer is an organo-silicon hybrid polymer.

A plasma used to treat an optical material may be any plasma capable of selectively interacting with one or more components of the optical material to form a “plasma-affected zone.” Such interactions may include etching, reaction, or deposition, among others, and the plasma-affected zone is a region of the treated optical material that is altered (physically or chemically, for example) by plasma exposure. The plasma may be generated from a substantially pure gas, or it may be generated from a mixture of two or more gases, which may include one or more inert gases. Plasma conditions may include a supplied gas type or mixture, gas flows, operating pressure, power, bias, and other variables. Surfaces may also be exposed to two or more plasma processes in a serial fashion.

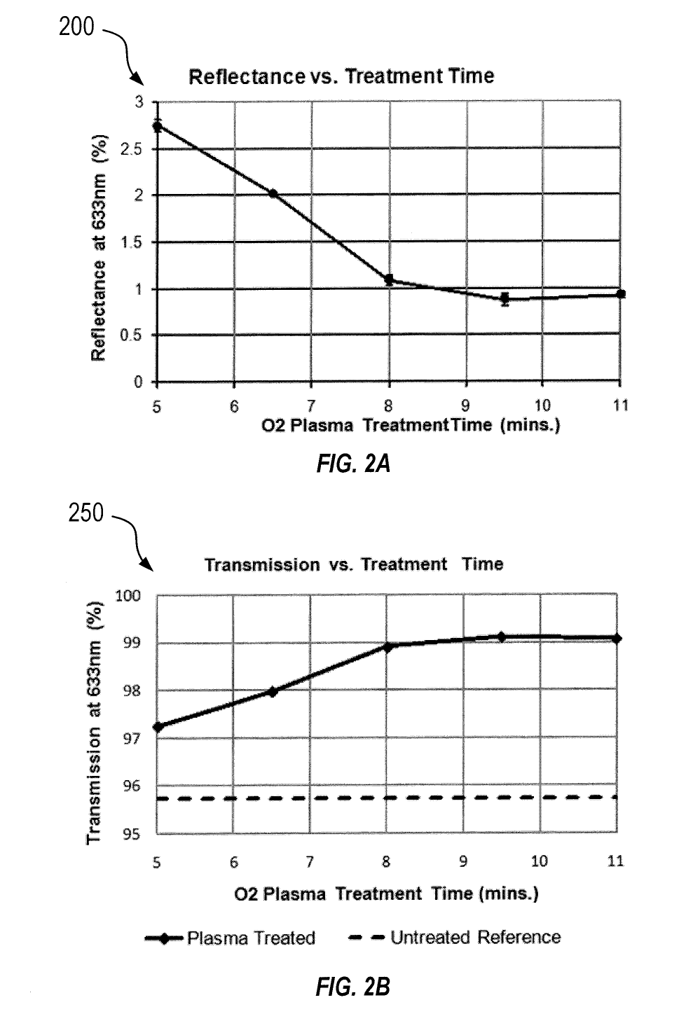

FIG. 2A shows a plot 200 of reflectance vs. plasma exposure time for an organo-silicon hybrid polymer optical material that was treated for varying amounts of time by exposure to an oxygen plasma. In this example, the inorganic component of the organic/inorganic hybrid polymer was silicon. An oxygen plasma was generated at 1 Torr process pressure, and 150 Watts, using a 13.56 MHz RF power supply. Exposure times ranged from 5 to 11 minutes. Reflectance from the treated and untreated optical material was measured using a 632.8 nm HeNe source and a Si power meter. The optical material was formed on a glass slide, the back of which was blackened, resulting in negligible backside reflectance from the sample. FIG. 2A illustrates that reflectance from a sample of organo-silicon hybrid polymer decreases with increasing oxygen plasma exposure (up to approximately 9.5 minutes exposure time). Similarly, FIG. 2B shows a plot 250 of transmission vs. plasma exposure time for the same treated optical material. This plot illustrates that transmission increases with plasma exposure time.

In one embodiment of process 100 illustrated in FIG. 1, plasma conditions may be chosen such that a plasma deposition occurs, forming either an inhomogeneous or a substantially homogeneous layer on the surface of an optical element. Such a layer, regardless of chemical composition, is also referred to herein as an “etch mask”. Etch masks may have organic, inorganic or hybrid organic-inorganic components, and may be polymeric or non-polymeric.

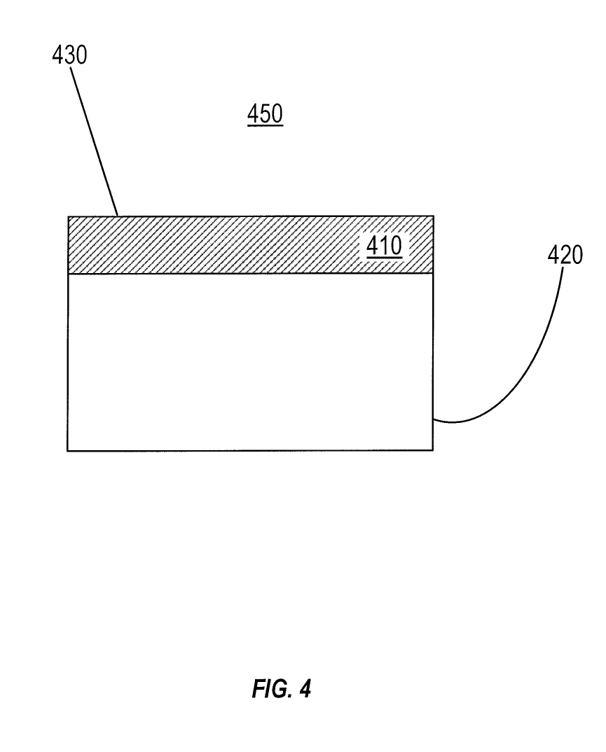

As illustrated in FIG. 4, a plasma may be utilized to deposit a substantially homogeneous etch mask 410 onto optical material 420. At least two conditions affect reflectivity of electromagnetic energy from surface 430 of etch mask 410. To minimize reflectivity for a particular wavelength of electromagnetic energy, the index of refraction of etch mask 410 may be chosen to satisfy EQN. 1:

n_{eff}=\sqrt{n₁×n₂} EQN. 1

where n_{eff} is the effective index of refraction of etch mask 410, n₁ is the index of refraction of a medium 450 that forms an interface with etch mask 410 at surface 430, and n₂ is the index of refraction of optical material 420. Reflectivity may also be minimized for a given incident wavelength if the thickness of etch mask 410 is one quarter of the given wavelength of the incident electromagnetic energy, as given by EQN. 2:

$$t = \frac{λ}{4} \cdot \frac{1}{{n}_{eff}} \qquad EQN . 2$$

where t is the thickness of etch mask 410, λ is the wavelength of incident electromagnetic energy and n_{eff} is the effective index of refraction of etch mask 410. For example, if medium 450 is air (n₁=1) and optical material 420 has an index of refraction n₂≅1.5 , then an ideal deposition layer would have n_{eff}≅1.232. For λ=600 nm, that ideal etch mask layer would have a thickness of ˜122 nm to minimize reflection. In practice, materials used for etch mask 410 may not exhibit the ideal n_{eff} given by EQN. 1 and may not be deposited at exactly the thickness given by EQN. 2. Slight deviations from these ideal values will still confer anti-reflective properties to an optical element as compared to having no etch mask present. Deviations of these sorts fall within the scope of the present embodiments.

In one embodiment of process 100 illustrated in FIG. 1 resulting in a structure described in FIG. 4, plasma conditions may be chosen to result in the deposition of a fluorocarbon-based polymer onto an optical element. Various fluorocarbon-based polymers have a range of index of refraction of ˜1.2-1.35. Such fluorocarbon-based polymers, if deposited on an optical element at thicknesses near one quarter of a wavelength near the center of a range of wavelengths of interest, may result in decreased reflectance of the optical element.

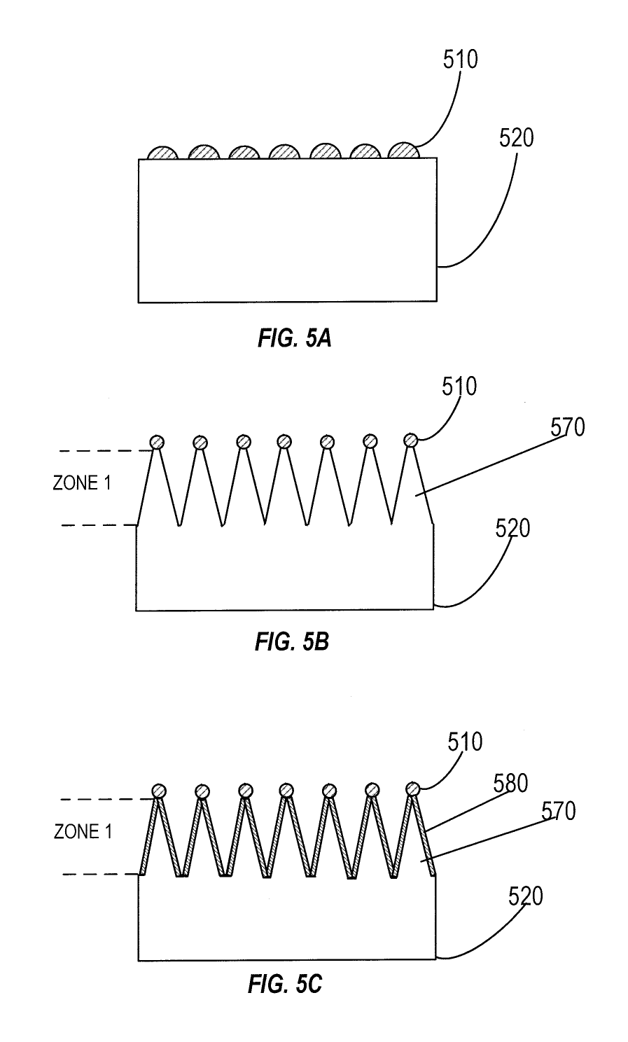

In another embodiment of process 100 illustrated in FIG. 1, plasma conditions may be chosen such that plasma treatment of an optical material results in deposition of an inhomogeneous etch mask on the optical material. One or more subsequent plasma treatments may form sub-wavelength-sized structures (within a range of wavelengths of interest) on a surface of the optical material, as illustrated in FIG. 5. An inhomogeneous layer in this instance may include a substantially solid layer of etch mask having pinholes or other voids interspersed therein, a sponge-like layer, thickness variations of the etch mask, or discrete islands of etch mask, among other variations. By way of example, FIG. 5A illustrates plasma deposition of an etch mask 510, in this case formed of discrete polymer islands, on an optical material 520. In this example, plasma conditions may be selected for a subsequent plasma etch such that optical material 520, exposed at discrete locations through pinholes or voids in etch mask 510, or upon etching away of thin regions of etch mask 510, etches at a faster rate than etch mask 510 (shown in FIG. 5B as discrete islands). Etching optical material 520 at discrete locations results in the formation of sub-wavelength structures 570 in the plasma-affected zone (labeled “Zone I”) of treated optical material 520, as illustrated in FIG. 5C. Sub-wavelength structures 570 formed in such a manner exhibit anti-reflective properties by providing an index of refraction gradient between a medium and optical material 520.

Alternatively, etch mask 510 may be formed using plasma deposition of non-polymeric materials such as SiO₂ or SiN. If optical material 520 is an organic polymer, a subsequent etch with an oxygen-containing plasma may result in preferential etch of exposed optical material 520 over etch mask 510. Additional etchants such as fluorine, may also be included in the plasma at varying concentrations to partially etch non-organic components of either etch mask 510, optical material 520, or both.

In a further embodiment, one or more additional etching processes may be chosen to selectively interact with sub-wavelength structures 570, either to chemically passivate structures 570, to provide an additional plasma-affected zone 580 (as shown in FIG. 5C) having an index of refraction between that of the etch polymer and that of the optical element material, or both. Providing such a secondary plasma-affected zone may create an effective index of refraction gradient between, for example, air (where n≈1.0) and optical material 520. If, for example, optical material 520 is formed from an organic-inorganic silicon containing polymer having an index of refraction of approximately 1.5, and etch mask 10 is formed from a fluorocarbon-based polymer having an index of refraction of approximately 1.28, then treating the nanostructures resulting from the plasma treatment described in FIG. 5B with an oxygen-containing plasma to preferentially etch any organic components present in optical material 520, may result in the formation of additional plasma-affected zone 580 on sub-wavelength structures 570 within plasma-affected zone 1.

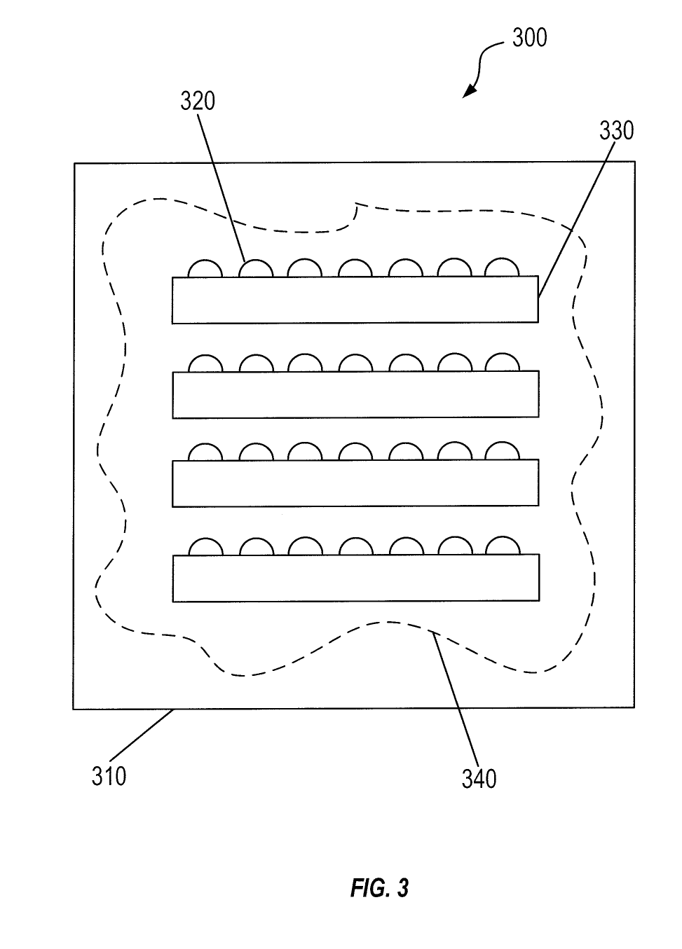

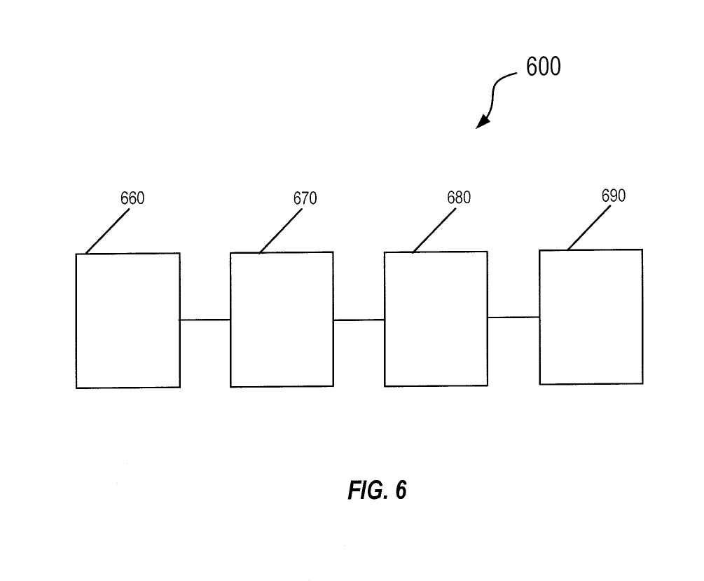

Optical elements may be treated with plasma one element at a time, or more than one element may be treated simultaneously, either as a group of single optical elements, one or more arrays of optical elements, multiple layers of optical elements, or as fully formed optics modules. FIG. 3 illustrates one example of treating multiple arrays of optical elements using a plasma process. In an exemplary system 300 illustrated in FIG. 3, arrays of optical elements 320, supported by a substrate 330, are exposed to a plasma 340 in a chamber 310. FIG. 3 illustrates that one or more arrays of optical elements may be treated with a plasma process to produce optical elements that exhibit decreased reflectivity relative to the untreated optical elements. These optical elements may then be utilized individually or on a wafer level to form optics modules, which may be integrated into an imaging system, as illustrated in FIG. 6. Imaging system 600 illustrates one embodiment of an imaging system that includes optics module 660, sensor 670, digital signal processor 680 and optional display 690. In this embodiment, optics module 600 includes at least one component that utilizes an optical material treated with plasma, as described herein.

While one example of plasma treatment of optical materials described in this disclosure relates to the treatment of an organo-silicon hybrid polymer optical material with an oxygen-containing plasma, it will be appreciated by those skilled in the art that the processes described and claimed herein may be adapted to plasma treatment of other optical materials or elements that results in reduced reflectivity at the surface of an optical element. Furthermore, although specific plasma conditions are described in the included example, other plasma conditions and components may be utilized to yield similar reductions in reflectivity for the same or different optical materials and may thus be considered to fall within the scope of the disclosed embodiments. It should thus be noted that the matter contained in the above description or shown in the accompanying drawings should be interpreted as illustrative and not in a limiting sense.

What is claimed is:

1. A method of forming an anti-reflective surface, comprising:
providing conditions for a plasma; and
exposing a surface of an organic-inorganic optical material to said plasma using said conditions, to form a treated optical material that exhibits lower reflectivity relative to said optical material prior to said step of exposing, to form the anti-reflective surface.

2. The method of claim 1 wherein exposing comprises providing an organo-silicon hybrid polymer as the organic-inorganic optical material.

3. The method of claim 1 wherein providing comprises providing a plasma that preferentially interacts with an organic component of the organic-inorganic optical material.

4. The method of claim 3 wherein providing the conditions for the plasma further comprises providing oxygen to form the plasma.

5. The method of claim 1 wherein providing further comprises providing an inert gas to form the plasma.

6. The method of claim 1 wherein providing further comprises providing an etchant.

7. The method of claim 6 wherein providing the conditions for the plasma further comprises providing fluorine.

8. The method of claim 1 wherein exposing causes said optical material to increase in transmission relative to said optical material prior to exposing.

9. A method of forming an anti-reflective surface, comprising:
depositing an etch mask on a surface of an optical material;
providing plasma conditions for a plasma such that said plasma etches said optical material preferentially over said etch mask; and
exposing said etch mask to said plasma using said plasma conditions to form a treated optical material having a plasma-affected zone, such that said optical material exhibits lower reflectivity relative to said optical material prior to exposing, thereby forming the anti-reflective surface.

10. The method of claim 9 wherein depositing comprises providing an organo-silicon hybrid polymer.

11. The method of claim 9 wherein providing comprises providing a plasma that preferentially interacts with an organic component of the optical material.

12. The method of claim 11 wherein providing the plasma conditions further comprises providing oxygen to form the plasma.

13. The method of claim 9 wherein providing further comprises providing an inert gas to form the plasma.

14. The method of claim 9 wherein providing further comprises providing an etchant.

15. The method of claim 14 wherein providing the plasma conditions further comprises providing fluorine.

16. The method of claim 9 wherein exposing causes said optical material to increase in transmission relative to said optical material prior to exposing.

17. The method of claim 9 wherein exposing comprises foaming sub-wavelength structures in the plasma-affected zone.

18. The method of claim 9 wherein depositing comprises depositing the etch mask as an inhomogeneous layer, so that during exposing, a portion of the optical material is also exposed.

19. The method of claim 18 wherein depositing the etch mask as an inhomogeneous layer comprises forming the etch mask with at least one of voids and thickness variations.

20. The method of claim 9 wherein depositing the etch mask comprises utilizing a plasma.
